(19) United States
(12) Patent Application Publication
(10) Pub. No.: US 2023/0151749 A1
(43) Pub. Date: May 18, 2023

(54) EXHAUST AFTERTREATMENT SYSTEM WITH ELECTRICAL CONNECTOR

(71) Applicant: Faurecia Emissions Control Technologies, USA, LLC, Columbus, IN (US)

(72) Inventor: John G. Rohde, Columbus, IN (US)

(21) Appl. No.: 17/529,776

(22) Filed: Nov. 18, 2021

(51) Int. Cl. F01N 3/20; H01R 13/11; H01R 13/627; B01D 53/94

(52) U.S. Cl. CPC F01N 3/2013; F01N 3/208; H01R 13/111; H01R 13/6277; B01D 53/9418; B01D 53/9431; F01N 2610/1453; F01N 2900/1404; F01N 2900/1602

(57) ABSTRACT

A vehicle includes an exhaust aftertreatment system for use with an automotive internal combustion engine. The aftertreatment system includes one or more aftertreatment devices for removing or reducing effluents from exhaust gases produced by the combustion engine. The aftertreatment devices includes a selective catalytic reduction unit that can be heated by a power source. An electrical connection system is configured to interconnect the power source and one or more electrical components to transfer and deliver electrical power to the one or more electrical components.

### BACKGROUND

The present disclosure relates to exhaust aftertreatment systems for treating exhaust gases produced in automotive applications, and particularly to an aftertreatment system for reducing or removing nitrogen oxides (NOx) from exhaust gases.

### SUMMARY

A vehicle in accordance with the present disclosure includes an engine and an exhaust aftertreatment system in accordance with the present disclosure. The engine combusts fuel and discharges exhaust gases through an interior space. The exhaust aftertreatment system is configured to reduce various undesired effluents in the exhaust gases, for example, NOx, before the exhaust gases are released to the atmosphere.

In illustrative embodiments, the exhaust aftertreatment system includes an exhaust housing and one or more exhaust aftertreatment devices coupled to the exhaust housing. The exhaust aftertreatment devices includes a selective catalytic reduction unit (SCR) and a doser mounted upstream of the SCR for injecting a reagent exhaust gases passing through an exhaust passageway defined by the exhaust housing. Chemical reaction of the reagent with the exhaust gases with the reagent occurs downstream of the doser in the SCR to transform the NOx into molecular nitrogen and water vapor which are not harmful to the environment.

In illustrative embodiments, the SCR includes a catalyst arranged to lie within the exhaust passageway and configured to encourage the chemical reaction between the exhaust gases and the reagent. In some situations, an efficiency of the chemical reaction can be improved by increasing a temperature of at least one of the catalyst or the exhaust gases and reagent passing therethrough. The SCR further includes an electrical conductor assembly coupled to the catalyst or a heater included in the catalyst and an electrical connector coupled between a power source and the electrical conductor assembly. The electrical conductor assembly and the electrical connector cooperate to supply electrical power from the power source to the catalyst or the heater to heat at least one of the catalyst or the exhaust gases and the reagent passing therethrough.

In illustrative embodiments, the electrical conductor assembly is mounted on the exhaust housing and insulates the electrical power from the exhaust housing. The electrical conductor assembly includes an outer mount sleeve coupled to the exhaust housing, an electrical conductor coupled between the electrical connector and the catalyst or the heater, and an insulative sleeve arranged between the outer mount sleeve and the electrical conductor. In some embodiments, axial forces are applied on the outer mount sleeve and radial forces are applied on the electrical conductor to retain the electrical conductor in place relative to the catalyst and the exhaust housing.

In illustrative embodiments, the electrical conductor is threadless and the electrical connector is attached to or removed from the electrical conductor by translating the electrical connector in only one direction. The electrical connector may be free to pivot relative to the electrical conductor so as not to impart substantial torque forced on the electrical conductor.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is perspective view of an automotive vehicle including an internal combustion engine and an exhaust aftertreatment system for treating exhaust gases produced by the combustion engine prior to being released to atmosphere;

FIG. 2 is a cross sectional view taken along line 2-2 in FIG. 1 showing a selective catalytic reduction unit included in the exhaust aftertreatment system, the selective catalytic reduction unit including a catalyst configured to encourage chemical reaction between the exhaust gases and a reagent injected into the exhaust gases upstream of the catalyst, an electrical conductor assembly mounted on an exhaust housing surrounding the catalyst and coupled to the catalyst, and an electrical connector coupled removably to the electrical conductor assembly to allow transfer of electrical power from a power source to the electrical conductor assembly to selectively heat the catalyst to increase an efficiency of the catalyst in low-temperature situations;

FIG. 3 is an enlarged view of a portion of FIG. 2 showing the electrical conductor assembly mounted on the exhaust housing and including an outer mount sleeve engaged with the exhaust housing, a threadless electrical conductor that extends through a conductor-receiving space defined by the outer mount sleeve, and an insulative sleeve that extends through the conductor-receiving space and that is arranged between the electrical conductor and the outer mount sleeve relative to a longitudinal axis of the outer mount sleeve, and showing that the electrical conductor is retained in place relative to the exhaust housing by radial forces acting on the electrical conductor and axial forces acting on the outer mount sleeve through and/or by the insulative sleeve;

FIG. 4 is an exploded assembly view showing the catalyst and the electrical conductor assembly separated from a portion of the exhaust housing;

FIG. 5 is an exploded assembly view of the electrical conductor assembly and the electrical connector showing that the electrical conductor assembly may further include first and second retainers configured to provide a compressive load on the insulative sleeve and the outer mount sleeve to retain the electrical conductor assembly in place and showing that insulative sleeve includes a first insulative sleeve section and a second insulative sleeve section each including a sleeve body arranged to lie between the outer mount sleeve and the electrical conductor and an insulative ring coupled to an end of each respective sleeve body and arranged to lie between each retainer and the outer mount sleeve;

FIG. 6 is a cross sectional view of the electrical conductor assembly and the electrical connector shown in FIGS. 1-5 showing that the electrical connector may include an outer insulative sleeve that covers the electrical connector and a portion of the electrical conductor assembly outside of the interior space when the electrical connector is fully installed; and

FIG. 7 is a cross sectional view of another embodiment of an electrical conductor assembly and an electrical connector adapted to couple with the electrical conductor assembly to allow transfer of electrical power from a power source to the catalyst shown in FIG. 2.

### DETAILED DESCRIPTION

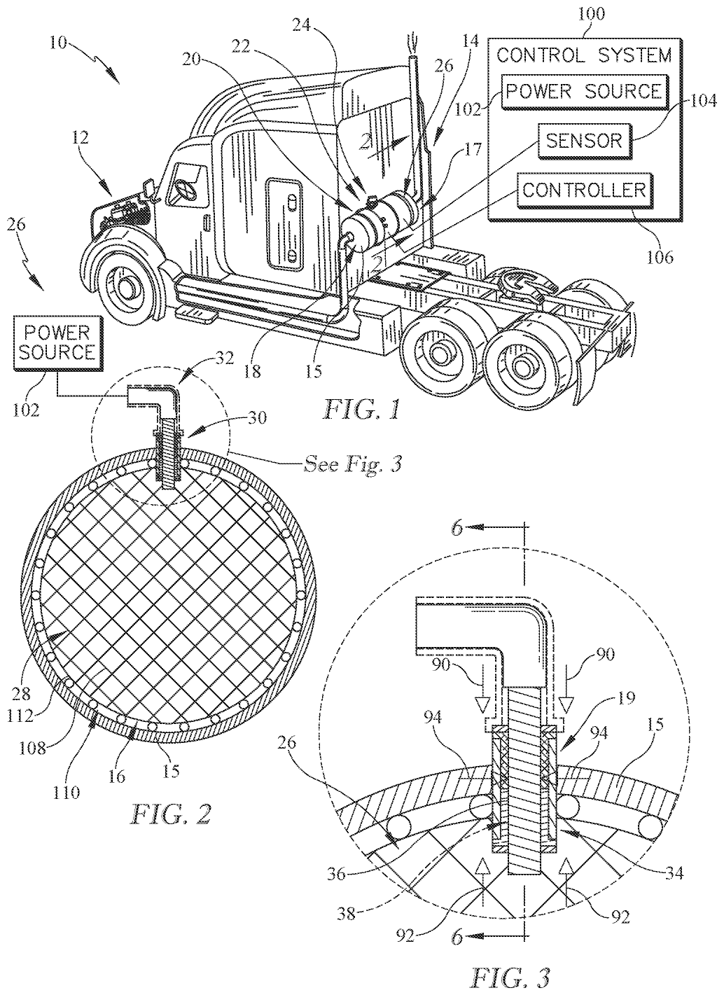

An illustrative over-the-road vehicle 10 includes an engine 12 and an exhaust aftertreatment system 14 in accordance with the present disclosure as shown in FIG. 1. The engine 12 is, illustratively, an internal combustion engine combusts fuel and discharges exhaust gases. The exhaust gases are distributed through an interior space 16, as shown in FIG. 2, treated by the exhaust aftertreatment system 14, and then released into the atmosphere. The exhaust aftertreatment system 14 is configured to reduce various undesired effluents in the exhaust gases, such as nitrogen oxides (NOx), before the exhaust gases are released to the atmosphere.

In the illustrative embodiment, the exhaust aftertreatment system 14 includes an exhaust housing 15 and one or more exhaust aftertreatment devices 17 such as a diesel oxidation catalyst (DOC) 18, a diesel particulate filter (DPF) 20, a mixer 22, a doser 24 coupled to the mixer 22, and a selective catalytic reduction unit (SCR) 26. The exhaust housing 15 defines the interior space 16. Each of the exhaust aftertreatment devices 17 is coupled to the exhaust housing 15 and/or located within the interior space 16 and is configured to interact with the exhaust gases produced by the engine 12 to remove or reduce different effluents from the exhaust gases prior to being released to the atmosphere.

The mixer 22, doser 24, and SCR 26 cooperate to reduce or remove NOx effluents from the exhaust gases. The doser 24 is coupled to the mixer 22 and is configured to inject a reagent into the exhaust gases upstream of the SCR 26. The reagent is, illustratively, a urea solution (i.e. Diesel Emission Fluid), however in other embodiments the reagent may be gaseous ammonia or other suitable chemicals. The mixer 22 is configured to induce mixing of the exhaust gases and the reagent upstream of the SCR 26. Chemical reaction of the reagent with the exhaust gases occurs downstream of the mixer 22 and the doser 24 in the SCR 26.

The SCR 26 includes a catalyst 28 that encourages chemical reaction of the reagent and the exhaust gases to transform the NOx effluents into molecular nitrogen and water vapor. In the illustrative embodiment, the exhaust aftertreatment system 14 further includes a control system 100 that controls operation of the doser 24 and to selectively heat the catalyst 28 in certain situations. The control system 100 includes a power source 102, a sensor 104, and a controller 106 as shown in FIG. 1. The power source 102 may be a battery, an alternator, a generator, or any other device suitable for providing and/or producing electrical power. The sensor 104 is illustratively a temperature sensor 104 and is configured measure a temperature of at least one of the exhaust gases and the catalyst 28. The controller 106 is configured to control output of electrical power from the power source 102 to the catalyst 28 in response to the temperature sensed by the sensor 104.

The catalyst 28 is selectively heatable by the control system 100 to increase an efficiency of the chemical reaction in low-temperature situations, such as start-up conditions of the engine 12 and until a temperature of the exhaust gases and/or the catalyst 28 reaches a predetermined temperature. The catalyst 28 includes catalyst media 108, a heater 110, and a conductive ring 112 surrounding the catalyst media 108. The catalyst media 108 is configured to encourage the chemical reaction between the exhaust gases and the reagent. The heater 110 is coupled to and/or integrated with the catalyst media 108 and increases in temperature when the electrical power passes through the heater 110 to heat the catalyst media 108 (i.e. by resistive heating). In some embodiments, the catalyst media 108 is conductive and is directly heated when the electrical power passes through the catalyst media 108. The conductive ring 112 is coupled to the heater 110 and receives electrical power and distributes the electrical power to the heater 110.

The SCR 26 further includes an electrical conductor assembly 30 coupled to the exhaust housing 15 and the catalyst 28 and an electrical connector 32 removably coupled to the electrical conductor assembly 30 as shown in FIG. 3. The electrical conductor assembly 30 allows transfer of electrical power to the catalyst 28 while insulating the electrical power from the exhaust housing 15. The electrical connector 32 extends between and interconnects the power source 102 and the electrical conductor assembly 30 to transfer the electrical power to the catalyst 28 through the electrical conductor assembly 30.

Together, the electrical conductor assembly 30 and the electrical connector 32 may be included in an electrical connection system that is configured to interconnect the power source 102 to one or more electrical components or devices. The electrical connection system is configured to transfer and deliver the electrical power to the one or more electrical components for consumption by the electrical component or device. The electrical conductor assembly 30 may be fixed to a non-electrical component (i.e. exhaust housing 15) relative to the electrical component or device while insulating other the non-electrical component from the electrical power provided by the power source 102.

The electrical conductor assembly 30 includes an outer mount sleeve 34, an electrical conductor 36, and an insulative sleeve 38 as shown in FIGS. 3-5. The outer mount sleeve 34 is coupled to the exhaust housing 15 to fix the electrical conductor assembly 30 in place relative to the exhaust housing 15. The electrical conductor 36 extends through a conductor-receiving space 40 defined by the outer mount sleeve 34 and is coupled directly to the electrical connector 32 to receive the electrical power therefrom. The insulative sleeve 38 is located between the outer mount sleeve 34 and the electrical conductor 36 to block passage of the electrical power from the electrical conductor 36 to the exhaust housing 15. In the illustrative embodiment, the insulative sleeve 38 is made from a ceramic material, however, in other embodiments, another suitable insulative material can be used such as a synthetic polymeric material.

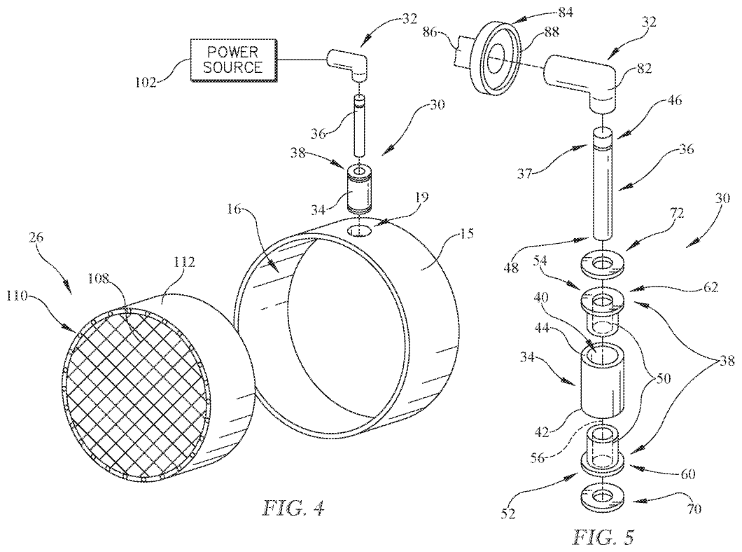

The outer mount sleeve 34 is illustratively embodied as a cylindrical tube as shown in FIGS. 4 and 5, however, in some embodiments, the outer mount sleeve 34 can have any polygonal shape. The outer mount sleeve 34 is made from a metallic material in the illustrative embodiment, however, in some embodiments, other suitable materials may be used. The exhaust housing 15 is formed to include an opening 19 that matches an outer surface 35 of the outer mount sleeve 34. The outer mount sleeve 34 may be press-fit with the exhaust housing 15 and/or joined in any suitable manner such as by welding, brazing, and soldering, for example. The outer mount sleeve 34 further includes an inner end 42 located within the interior space 16 and an outer end 44 located outside of the interior space 16.

The electrical conductor 36 is illustratively embodied as a cylindrical rod to match a shape of the outer mount sleeve 34 and the insulative sleeve 38, however, in some embodiments, any suitable polygonal shape may be used. The electrical conductor 36 is threadless but is formed to include an annular channel 37 at an outer end 46 of the electrical conductor 36 that is configured to receive the electrical connector 32. An inner end 48 of the electrical conductor 36 is engaged with the conductive ring 112 of the catalyst 28. The electrical connector 32 includes at least one connector retainer 33 that extends into the annular channel 37 to retain the electrical connector 32 to the electrical conductor 36. The at least one connector retainer 33 is free to slide through the annular channel 37 such that the electrical connector 32 is free to pivot relative to the electrical conductor 36 without imparting substantial torque on the electrical conductor 36.

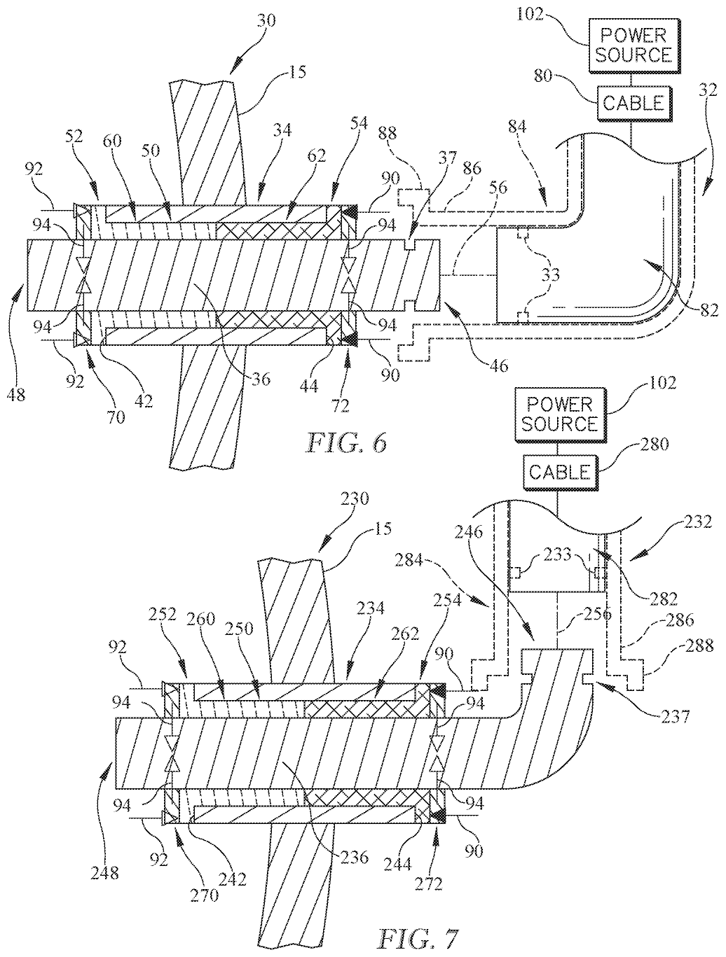

The insulative sleeve 38 includes a sleeve body 50, a first insulative ring 52 coupled to an inner end of the sleeve body 50, and a second insulative ring 54 coupled to an opposite, outer end of the sleeve body 50 as shown in FIGS. 5 and 6. The sleeve body 50 is arranged between the outer mount sleeve 34 and the electrical conductor 36 to separate the electrical conductor 36 from the exhaust housing 15. The first insulative ring 52 extends radially outward away from the electrical conductor 36 to engage an axial surface of the inner end 42 of the outer mount sleeve 34 relative to a longitudinal axis 56 of the outer mount sleeve 34. The second insulative ring 54 extends radially outward away from the electrical conductor 36 and engages an axial surface of the outer end 44 of the outer mount sleeve 34.

At least one of the sleeve body 50, the first insulative ring 52, and the second insulative ring 54 may be sized so as to be press-fit with the electrical conductor 36 when the electrical conductor assembly 30 is fully assembled. The first and second insulative rings 52, 54 may engage the outer mount sleeve 34 and impart opposing inward forces 90, 92 on the inner and outer ends 42, 44 of the outer mount sleeve 34. The opposing inward forces 90, 92 may provide a compressive load on the outer mount sleeve 34. The insulative sleeve 38 may also impart a radial force 94 toward and on the electrical conductor 36 so as to frictionally engage the electrical conductor 36 and block movement of the electrical conductor 36 relative to the outer mount sleeve 34 and the exhaust housing 15. Accordingly, an outer diameter of the electrical conductor 36 may be slightly larger than an inner diameter of the insulative sleeve 38 so as to provide a friction-interference fit therebetween. In some embodiments, the radially inward force 94 is provided by the outer mount sleeve 34 to the electrical conductor 36 through the insulative sleeve 38 such that a friction-interference is provided between the outer mount sleeve 34 and the insulative sleeve 38 and between the insulative sleeve 38 and the electrical conductor 36.

In some embodiments, the sleeve body 50 includes a first sleeve-body section 60 and a second sleeve-body section 62 separate from the first sleeve-body section 60 as shown in FIGS. 5 and 6. The first sleeve-body section 60 is integral with the first insulative ring 52. The second sleeve-body section 62 is integral with the second insulative ring 54. In the illustrative embodiment, the combined the first sleeve-body section 60 and the first insulative ring 52 is identical to the combined second sleeve-body section 62 and the second insulative ring 54 to facilitate installation and manufacturing of the insulative sleeve 38.

During installation and assembly of the electrical conductor assembly 30, the first sleeve-body section 60 is inserted into the outer mount sleeve 34 from the inner end 42 until the first insulative ring 52 engages the inner end 42 of the outer mount sleeve 34. The second sleeve-body section 62 is inserted into the outer mount sleeve 34 from the outer end 44 until the second insulative ring 54 engages the outer end 44 of the outer mount sleeve 34. The electrical conductor 36 may then be inserted into the insulative sleeve 38 from either direction to complete assembly of the electrical conductor assembly 30. The outer mount sleeve 34 may then be secured to the exhaust housing 15.

In some embodiments, the electrical conductor assembly 30 further includes a first retainer 70 and a second retainer 72 as shown in FIGS. 5 and 6. The first retainer 70 and the second retainer 72 are each illustratively embodied as a washer that may be press fit with the electrical conductor 36 and in engagement with the first and second insulative rings 52, 54, respectively. In some embodiments, the first and second retainers 70, 72 may be a clip, fastener, weld bead, or any other suitable structure that is coupled to the electrical conductor 36.

The first insulative ring 52 is located between the inner end 42 of the outer mount sleeve 34 and the first retainer 70. The second insulative ring 54 is located between the outer end 44 of the outer mount sleeve 34 and the second retainer 72. In this way, the retainers 70, 72 are insulated from the exhaust housing 15 to disrupt any electrical path from the electrical conductor 36, through the retainers 70, 72, and to the exhaust housing 15.

The first and second retainers 70, 72, when included, apply radial forces 94 on the electrical conductor 36 and the inward forces 90, 92 through the insulative rings 52, 54 to the outer mount sleeve 34. In this arrangement, the retainers 70, 72 apply the forces 90, 92 on the outer mount sleeve 34 and the insulative sleeve 38. The insulative rings 52, 54 provide the forces 90, 92 on the outer mount sleeve 38, but when the first and second retainers 70, 72 are included, the insulative rings 52, 54 may not be the cause of the forces 90, 92. The first and second retainers 70, 72 may have an inner diameter that is slightly less than the outer diameter of the electrical conductor 36 to provide a friction-interference fit therebetween.

The electrical connector 32 includes a cable 80, a connector head 82 coupled to the cable 80, and an insulative connector sleeve 84 as shown in FIGS. 5 and 6. The cable 80 is coupled to the power source 102 to transfer the electrical power therefrom. The cable 80 may be flexible or ridged. The connector head 82 is coupled to a distal end of the cable 80 and is configured to be attached removably to the electrical conductor 36. The connector head 82 includes the connector retainer(s) 50 that engage the channel 37 formed on the conductor 36. The insulative connector sleeve 84 surrounds the cable 80 and the connector head 82 to block passage of the electrical power.

The insulative connector sleeve 84 includes a sleeve tube 86 and a sleeve head 88 as shown in FIGS. 5 and 6. The sleeve tube 86 surrounds the cable 80 and the connector head 82. The sleeve tube 86 and the sleeve head 88 extend past the connector head 82 toward the electrical conductor assembly 30. The sleeve head 88 may have an outer diameter that is greater than the a diameter of the sleeve tube 86. The sleeve head 88 is sized to fit around the retainer 72 to block passage of the electrical power from the retainer 72.

Another embodiment of an electrical conductor assembly 230 is shown in FIG. 7. The electrical conductor assembly 230 is substantially similar to electrical conductor assembly 30. Accordingly, similar reference numbers in the 200 series are used to indicate common features between electrical conductor assembly 230 and electrical conductor assembly 30. The disclosure of electrical conductor assembly 30 is incorporated by reference for electrical conductor assembly 230.

The electrical conductor assembly 230 includes a conductor 236 that has an outer end 244 that is curved as shown in FIG. 7. The curved outer end 244 of the conductor 236 allows the conductor to receive an electrical connector 232 having a different shape than electrical connector 32. The electrical conductor 236 can be shaped as desired to fit any type of electrical connector.

The following numbered clauses include embodiments that are contemplated and non-limiting:

Clause 1. An exhaust aftertreatment system for an over-the-road vehicle, the exhaust aftertreatment system comprising
an exhaust housing defining an interior space configured to direct exhaust gases to atmosphere downstream of the exhaust aftertreatment system,
a doser coupled to the exhaust housing and configured to inject a reagent into the interior space for mixture with the exhaust gases, and
a selective catalytic reduction unit coupled to the exhaust housing downstream of the doser and configured to receive the exhaust gases and the reagent,
wherein the selective catalytic reduction unit includes:
   (i) a catalyst arranged within the interior space and configured to encourage chemical reaction between the exhaust gases and the reagent and reduce nitrogen oxides in the exhaust gases,
   (ii) an electrical connector coupled to a power source and configured to provide electricity to the selective catalytic reduction unit to selectively heat the catalyst, and
   (iii) an electrical-conductor assembly including an outer mount sleeve fixed to the exhaust housing and defining a conductor receiving space, an electrical conductor arranged to lie within the conductor receiving space and extending between and interconnecting the electrical connector and the catalyst, and an inner insulative sleeve arranged to lie within the conductor receiving space, the inner insulative sleeve including a sleeve body arranged between the outer mount sleeve and the electrical conductor, a first insulative ring arranged at an inner end of the outer mount sleeve, and a second insulative ring arranged at an outer end of the outer mount sleeve.

Clause 2. The aftertreatment system of clause 1, any other clause or any suitable combination of clauses, wherein the sleeve-body includes a first sleeve-body section and a second sleeve-body section separate from the first sleeve-body section, and wherein the first sleeve-body section is integral with the first insulative ring and the second sleeve-body section is integral with the second insulative ring.

Clause 3. The aftertreatment system of clause 2, any other clause or any suitable combination of clauses, wherein the first sleeve-body section and the second sleeve-body section are press-fit with the electrical conductor so that the first insulative ring and the second insulative ring apply a compressive load on the outer mount sleeve.

Clause 4. The aftertreatment system of clause 2, any other clause or any suitable combination of clauses, wherein the electrical-conductor assembly further includes: (iv) a first retainer coupled to the electrical conductor and the first insulative ring to locate the first insulative ring between the inner end of the outer mount sleeve and the first retainer and (v) a second retainer coupled to the electrical conductor and the second insulative ring to locate the second insulative ring between the outer end of the outer mount sleeve and the second retainer.

Clause 5. The aftertreatment system of clause 4, any other clause or any suitable combination of clauses, wherein first and second retainers are press-fit with the electrical conductor and cooperate to provide a compressive load through the first insulative ring and the second insulative ring to the outer mount sleeve.

Clause 6. The aftertreatment system of clause 1, any other clause or any suitable combination of clauses, further comprising a control system including the power source, a temperature sensor configured to measure a temperature of at least one of the catalyst and the exhaust gases, and a controller configured to selectively provide power from the power source to the catalyst to heat the catalyst when the temperature is below a predetermined threshold.

Clause 7. The aftertreatment system of clause 1, any other clause or any suitable combination of clauses, wherein the electrical conductor includes an outer end arranged outside of the interior space and an inner end arranged within the interior space, and wherein the outer end is formed without threads and includes an annular channel that is configured to engage one or more connector retainers that extend into the annular channel such that the electrical connector is free to pivot about the outer end of the electrical conductor.

Clause 8. A selective catalytic reduction unit for an exhaust aftertreatment system having an exhaust housing defining an interior space, the aftertreatment system comprising
a catalyst arranged within the interior space and adapted to encourage chemical reaction between exhaust gases and reagent flowing therethrough to reduce nitrogen oxides in the exhaust gases,
an electrical connector configured to transfer electricity to selectively heat the catalyst, and
an electrical-conductor assembly including an outer mount sleeve fixed to the exhaust housing and defining a conductor receiving space, an electrical conductor arranged to lie within the conductor receiving space and extending between and interconnecting the electrical connector and the catalyst, and an inner insulative sleeve arranged to lie within the conductor receiving space, the inner insulative sleeve including a sleeve body arranged between the outer mount sleeve and the electrical conductor, a first insulative ring arranged at an inner end of the outer mount sleeve and configured to impart an outward force on the outer mount sleeve, and a second insulative ring arranged at an outer end of the outer mount sleeve and configured to impart an inward force on the outer mount sleeve such that a compressive load is applied on the outer mount sleeve through the first and second insulative rings to retain the electrical conductor and the insulative sleeve in place relative to the exhaust housing.

Clause 9. The selective catalytic reduction unit of clause 8, any other clause or any suitable combination of clauses, wherein the sleeve body includes a first sleeve-body section and a second sleeve-body section separate from the first sleeve-body section, and wherein the first sleeve-body section is integral with the first insulative ring and the second sleeve-body section is integral with the second insulative ring.

Clause 10. The selective catalytic reduction unit of clause 9, any other clause or any suitable combination of clauses, wherein the first sleeve-body section and the second sleeve-body section are press-fit with the electrical conductor and the first insulative ring and the second insulative ring apply the compressive load on opposing ends of the outer mount sleeve.

Clause 11. The selective catalytic reduction unit of clause 10, any other clause or any suitable combination of clauses, wherein the electrical-conductor assembly further includes: (iv) a first retainer coupled to the electrical conductor and the first insulative ring to locate the first insulative ring between the inner end of the outer mount sleeve and the first retainer and (v) a second retainer coupled to the electrical conductor and the second insulative ring to locate the second insulative ring between the outer end of the outer mount sleeve and the second retainer.

Clause 12. The selective catalytic reduction unit of clause 11, any other clause or any suitable combination of clauses, wherein first and second retainers are press-fit with the electrical conductor and cooperate to provide the compressive load through the first insulative ring and the second insulative ring to the outer mount sleeve.

Clause 13. The selective catalytic reduction unit of clause 8, any other clause or any suitable combination of clauses, wherein the electrical conductor includes an outer end arranged outside of the interior space and an inner end arranged within the interior space, and wherein the outer end is formed without threads and includes an annular channel that is configured to engage one or more connector retainers that extend into the annular channel such that the electrical connector is free to pivot about the outer end of the electrical conductor.

Clause 14. An electrical connection system configured to interconnect a power source and an electrical component, the electrical connection system comprising
an electrical connector coupled to the power source and
an electrical-conductor assembly removably coupled with the electrical connector, the electrical-conductor assembly including an outer mount sleeve adapted to be fixed relative to the electrical component and defining a conductor receiving space, an electrical conductor arranged to lie within the conductor receiving space and extending between and interconnecting the electrical connector and the electrical component, and an inner insulative sleeve arranged to lie within the conductor receiving space,
wherein the inner insulative sleeve includes a sleeve body arranged between the outer mount sleeve and the electrical conductor, a first insulative ring surrounding the electrical conductor and arranged at an first end of the outer mount sleeve, and a second insulative ring surrounding the electrical conductor and arranged at a second end of the outer mount sleeve to locate the outer mount sleeve axially between the first insulative ring and the second insulative ring.

Clause 15. The electrical connection system of clause 14, any other clause or any suitable combination of clauses, wherein a first force is provided on the first end of the outer mount sleeve and an opposite, second force is provided on the second end of the outer mount sleeve such that a compressive load is applied on the outer mount sleeve through the first and second insulative rings to retain the electrical conductor and the insulative sleeve in place relative to the exhaust housing.

Clause 16. The electrical connection system of clause 15, any other clause or any suitable combination of clauses, wherein the sleeve body includes a first sleeve-body section and a second sleeve-body section separate from the first sleeve-body section, and wherein the first sleeve-body section is integral with the first insulative ring and the second sleeve-body section is integral with the second insulative ring.

Clause 17. The electrical connection system of clause 16, any other clause or any suitable combination of clauses, wherein first insulative ring and the second insulative ring are press-fit with the electrical conductor such that the first insulative ring and the second insulative ring apply the compressive load on the outer mount sleeve.

Clause 18. The electrical connection system of clause 14, any other clause or any suitable combination of clauses, wherein the electrical-conductor assembly further includes: (iv) a first retainer coupled to the electrical conductor and the first insulative ring to locate the first insulative ring between the first end of the outer mount sleeve and the first retainer and (v) a second retainer coupled to the electrical conductor and the second insulative ring to locate the second insulative ring between the second end of the outer mount sleeve and the second retainer.

Clause 19. The electrical connection system of clause 18, any other clause or any suitable combination of clauses, wherein first and second retainers are press-fit with the electrical conductor and cooperate to provide the compressive load through the first insulative ring and the second insulative ring to the outer mount sleeve.

Clause 20. The electrical connection system of clause 14, any other clause or any suitable combination of clauses, wherein the electrical conductor includes an outer end configured to couple with the electrical connector and an inner end configured to couple with the electrical component and wherein the outer end is formed without threads and includes an annular channel that is configured to engage one or more connector retainers of the electrical connector that extend into the annular channel such that the electrical connector is free to pivot about the outer end of the electrical conductor.

1. An exhaust aftertreatment system for an over-the-road vehicle, the exhaust aftertreatment system comprising
an exhaust housing defining an interior space configured to direct exhaust gases to atmosphere downstream of the exhaust aftertreatment system,
a doser coupled to the exhaust housing and configured to inject a reagent into the interior space for mixture with the exhaust gases, and
a selective catalytic reduction unit coupled to the exhaust housing downstream of the doser and configured to receive the exhaust gases and the reagent,
wherein the selective catalytic reduction unit includes:
(i) a catalyst arranged within the interior space and configured to encourage chemical reaction between the exhaust gases and the reagent and reduce nitrogen oxides in the exhaust gases,
(ii) an electrical connector coupled to a power source and configured to provide electricity to the selective catalytic reduction unit to selectively heat the catalyst, and
(iii) an electrical-conductor assembly including an outer mount sleeve fixed to the exhaust housing and defining a conductor receiving space, an electrical conductor arranged to lie within the conductor receiving space and extending between and interconnecting the electrical connector and the catalyst, and an inner insulative sleeve arranged to lie within the conductor receiving space, the inner insulative sleeve including a sleeve body arranged between the outer mount sleeve and the electrical conductor, a first insulative ring arranged at an inner end of the outer mount sleeve, and a second insulative ring arranged at an outer end of the outer mount sleeve.

2. The aftertreatment system of claim 1, wherein the sleeve-body includes a first sleeve-body section and a second sleeve-body section separate from the first sleeve-body section, and wherein the first sleeve-body section is integral with the first insulative ring and the second sleeve-body section is integral with the second insulative ring.

3. The aftertreatment system of claim 2, wherein the first sleeve-body section and the second sleeve-body section are press-fit with the electrical conductor so that the first insulative ring and the second insulative ring apply a compressive load on the outer mount sleeve.

4. The aftertreatment system of claim 2, wherein the electrical-conductor assembly further includes: (iv) a first retainer coupled to the electrical conductor and the first insulative ring to locate the first insulative ring between the inner end of the outer mount sleeve and the first retainer and (v) a second retainer coupled to the electrical conductor and the second insulative ring to locate the second insulative ring between the outer end of the outer mount sleeve and the second retainer.

5. The aftertreatment system of claim 4, wherein first and second retainers are press-fit with the electrical conductor and cooperate to provide a compressive load through the first insulative ring and the second insulative ring to the outer mount sleeve.

6. The aftertreatment system of claim 1, further comprising a control system including the power source, a temperature sensor configured to measure a temperature of at least one of the catalyst and the exhaust gases, and a controller configured to selectively provide power from the power source to the catalyst to heat the catalyst when the temperature is below a predetermined threshold.

7. The aftertreatment system of claim 1, wherein the electrical conductor includes an outer end arranged outside of the interior space and an inner end arranged within the interior space, and wherein the outer end is formed without threads and includes an annular channel that is configured to engage one or more connector retainers that extend into the annular channel such that the electrical connector is free to pivot about the outer end of the electrical conductor.

8. A selective catalytic reduction unit for an exhaust aftertreatment system having an exhaust housing defining an interior space, the aftertreatment system comprising
a catalyst arranged within the interior space and adapted to encourage chemical reaction between exhaust gases and reagent flowing therethrough to reduce nitrogen oxides in the exhaust gases,
an electrical connector configured to transfer electricity to selectively heat the catalyst, and
an electrical-conductor assembly including an outer mount sleeve fixed to the exhaust housing and defining a conductor receiving space, an electrical conductor arranged to lie within the conductor receiving space and extending between and interconnecting the electrical connector and the catalyst, and an inner insulative sleeve arranged to lie within the conductor receiving space, the inner insulative sleeve including a sleeve body arranged between the outer mount sleeve and the electrical conductor, a first insulative ring arranged at an inner end of the outer mount sleeve to provide a first force on the outer mount sleeve, and a second insulative ring arranged at an outer end of the outer mount sleeve to provide an opposite, second force on the outer mount sleeve such that a compressive load is applied on the outer mount sleeve through the first and second insulative rings to retain the electrical conductor and the insulative sleeve in place relative to the exhaust housing.

9. The selective catalytic reduction unit of claim 8, wherein the sleeve body includes a first sleeve-body section and a second sleeve-body section separate from the first sleeve-body section, and wherein the first sleeve-body section is integral with the first insulative ring and the second sleeve-body section is integral with the second insulative ring.

10. The selective catalytic reduction unit of claim 9, wherein the first sleeve-body section and the second sleeve-body section are press-fit with the electrical conductor and the first insulative ring and the second insulative ring apply the compressive load on opposing ends of the outer mount sleeve.

11. The selective catalytic reduction unit of claim 9, wherein the electrical-conductor assembly further includes: a first retainer coupled to the electrical conductor and the first insulative ring to locate the first insulative ring between the inner end of the outer mount sleeve and the first retainer and a second retainer coupled to the electrical conductor and the second insulative ring to locate the second insulative ring between the outer end of the outer mount sleeve and the second retainer.

12. The selective catalytic reduction unit of claim 11, wherein first and second retainers are press-fit with the electrical conductor and cooperate to provide the compressive load through the first insulative ring and the second insulative ring to the outer mount sleeve.

13. The selective catalytic reduction unit of claim 8, wherein the electrical conductor includes an outer end arranged outside of the interior space and an inner end arranged within the interior space, and wherein the outer end is formed without threads and includes an annular channel that is configured to engage one or more connector retainers that extend into the annular channel such that the electrical connector is free to pivot about the outer end of the electrical conductor.

14. An electrical connection system configured to interconnect a power source and an electrical component, the electrical connection system comprising
an electrical connector coupled to the power source and
an electrical-conductor assembly removably coupled with the electrical connector, the electrical-conductor assembly including an outer mount sleeve adapted to be fixed relative to the electrical component and defining a conductor receiving space, an electrical conductor arranged to lie within the conductor receiving space and extending between and interconnecting the electrical connector and the electrical component, and an inner insulative sleeve arranged to lie within the conductor receiving space,
wherein the inner insulative sleeve includes a sleeve body arranged between the outer mount sleeve and the electrical conductor, a first insulative ring surrounding the electrical conductor and arranged to engage a first end of the outer mount sleeve, and a second insulative ring surrounding the electrical conductor and arranged to engage an opposite, second end of the outer mount sleeve to locate the outer mount sleeve axially between the first insulative ring and the second insulative ring.

15. The electrical connection system of claim 14, wherein a first force is provided on the first end of the outer mount sleeve and an opposite, second force is provided on the second end of the outer mount sleeve such that a compressive load is applied on the outer mount sleeve through the first and second insulative rings to retain the electrical conductor and the insulative sleeve in place relative to the exhaust housing.

16. The electrical connection system of claim 15, wherein the sleeve body includes a first sleeve-body section and a second sleeve-body section separate from the first sleeve-body section, and wherein the first sleeve-body section is integral with the first insulative ring and the second sleeve-body section is integral with the second insulative ring.

17. The electrical connection system of claim 16, wherein first insulative ring and the second insulative ring are press-fit with the electrical conductor such that the first insulative ring and the second insulative ring apply the compressive load on the outer mount sleeve.

18. The electrical connection system of claim 14, wherein the electrical-conductor assembly further includes: a first retainer coupled to the electrical conductor and the first insulative ring to locate the first insulative ring between the first end of the outer mount sleeve and the first retainer and a second retainer coupled to the electrical conductor and the second insulative ring to locate the second insulative ring between the second end of the outer mount sleeve and the second retainer.

19. The electrical connection system of claim 18, wherein first and second retainers are press-fit with the electrical conductor and cooperate to provide the compressive load through the first insulative ring and the second insulative ring to the outer mount sleeve.

20. The electrical connection system of claim 14, wherein the electrical conductor includes an outer end configured to couple with the electrical connector and an inner end configured to couple with the electrical component and wherein the outer end is formed without threads and includes an annular channel that is configured to engage one or more connector retainers of the electrical connector that extend into the annular channel such that the electrical connector is free to pivot about the outer end of the electrical conductor.
